(19) United States
(12) Patent Application Publication
(10) Pub. No.: US 2015/0337561 A1
(43) Pub. Date: Nov. 26, 2015

(54) PRODUCING A LOCK AND MATCHING KEY

(71) Applicant: International Business Machines Corporation, Armonk, NY (US)

(72) Inventors: Alan B. Dawson, Eastleigh (GB); Gordon D. Hutchison, Eastleigh (GB)

(21) Appl. No.: 14/707,342

(22) Filed: May 8, 2015

(30) Foreign Application Priority Data
May 22, 2014 (GB) 1409148.2

(51) Int. Cl. E05B 17/00; E05B 19/00; G05B 19/4097

(52) U.S. Cl. CPC E05B 17/0004; G05B 19/4097; E05B 19/00

(57) ABSTRACT

Technology for producing and/or reproducing a lock and/or matching key in which a user enters a personally selected alphanumeric input, such as a password or passphrase, or other personally memorable data, to an input processor. The alphanumeric input is converted by a deterministic transformation function, such as a hashing function, to an alphanumeric output which corresponds to a key cutting code. A manufacturing apparatus makes a lock and key corresponding to this code. When the same personally selected alphanumeric input is entered by the user, the deterministic transformation function outputs the same key cutting code which is used to make a duplicate key. The duplicate key may be made by a 3D printer and the deterministic transformation function may be part of a network-provided service. In this way, key reproduction can be accomplished without storing a key cutting code.

### BACKGROUND

The invention relates to a method for producing a lock and matching key. More particularly, the invention relates to a method for producing a lock and matching key using alphanumeric data provided by a user, and for subsequently reproducing the key by using the data provided by the user.

Locksmiths and many other enterprises provide key copying services in which an owner's key may be used as a master to produce a copy by cutting a suitable key blank to the same shape. The master key is inserted into a duplicating machine which includes a profile follower mechanism for moving along the profile of the key which typically includes a unique pattern of peaks and troughs. The profile pattern followed is transferred exactly to a cutting mechanism which reproduces the followed profile by cutting a suitable inserted key blank into the same profile pattern. A duplicate key results which operates the same lock as the master key.

This method requires a key for duplication, and is useless where all keys to a lock are lost or are unavailable. A further problem arises where the master key for duplication has become worn through prolonged use and does not function reliably to open its lock because of the altered profile. A copy of such a key will reproduce the worn profile and, therefore, similarly fail to function reliably.

U.S. Pat. No. 3,496,636 states as follows: “A machine for cutting key blanks . . . which utilizes adjustable depth gauges in association with a movable key blank supporting member for varying the depth of the cuts on the key blank in accordance with a known or determinable code pattern . . . . The extent of incremental traversing movement of the key blank can be varied to conform to different pre-established spacings between the cuts on various types of key blanks, by adjustment of the length of stroke which actuates the traversing or spacing mechanism. The spacing of the gauge elements themselves can be fixed or adjustable.”

U.S. Pat. No. 5,271,698 states as follows: “A code selectable key duplicating system is adapted to function with a key cutting machine having a key follower for engaging and tracing the contour of a bit notch pattern formed in the blade of a master key and a key cutter coupled to the key follower to reproduce the traced bit notch pattern of the master key in the blade of a key blank. The code selectable duplicating system includes a bit notch simulator which is divided into a selectable series of n adjacent notch segments to form a surface contour creating a simulated bit notch pattern corresponding to the bit notch pattern designated by a coded sequence. An alignment fixture positions the notch pattern simulator relative to the key follower enabling the key follower to trace the simulated bit notch pattern such that the key cutter reproduces the simulated bit notch pattern in the blade of the key blank.”

United States published patent application US 2013/0331976 states as follows: “A key-duplicating system comprises a network that includes a multiplicity of kiosks at a multiplicity of different locations, each of the kiosks having a customer interface and a processor coupled to the customer interface. A remote central server coupled to the kiosks is adapted to receive, from the kiosks, information identifying master keys to be duplicated. A key analysis module uses the information identifying master keys to be duplicated to derive information required to produce duplicates of the identified master keys, and a key duplicating module uses that information to produce duplicates of said identified master keys.”

FIG. 1 illustrates a conventional method for reproducing a key using a code selectable key duplicating system. Key 100 may be cut from a key blank having uncut profile level indicated by dotted line 110. Key 100 comprises equally spaced coded data fields 120 along the length of the key. In the illustrated example, eight coded data fields are sequentially numbered along the key as coded data field positions 1 to 8. Each coded data field position comprises coded data field content 130, the coded data field content comprising a number from 0 to 9 which represents the depth of the notch cut in the key blank at that position, 0 representing the shallowest notch increasing successively in depth of cut to 9 representing the deepest notch. According to this prior art method, data field content numbers are allocated sequentially at each data field position along the key to produce a code for the key. In this case, reading sequentially along field positions 1 to 8 produces a key code 140. In the illustrated example, the key code 140 is 24120813. This code may then represent the key to a key duplicating system which reads the code and uses it to direct the depth of cut at each data field position of a cutting apparatus for cutting a duplicate key from a key blank.

### SUMMARY

According to an aspect of the present invention, there is a method, computer program product and/or system for producing a lock and matching key that performs the following operations (not necessarily in the following order): receiving an alphanumeric input from a user, the alphanumeric input includes a personally selected alphanumeric input; converting by a deterministic transformation function the alphanumeric input to an alphanumeric output corresponding to a key cutting code; and manufacturing a lock and matching key corresponding to the key cutting code.

According to an aspect of the present invention, there is a method, computer program product and/or system for producing a key that performs the following operations (not necessarily in the following order): identifying a deterministic transformation function previously used to convert a received alphanumeric input including a personally selected alphanumeric input to an alphanumeric output corresponding to a key cutting code; receiving the same alphanumeric input from a user; converting by the deterministic transformation function the alphanumeric input to the alphanumeric output corresponding to the key cutting code; and manufacturing a key corresponding to the key cutting code.

According to a further aspect of the present invention, a system for producing a key includes: an identifying component; a user input processor; an input information transformation processor; and a key manufacturing apparatus. The identifying component identifies a deterministic transformation function previously used to convert a received alphanumeric input comprising a personally selected alphanumeric input to an alphanumeric output corresponding to a key cutting code. The user input processor receives the same alphanumeric input from a user. The input information transformation processor for converting by the deterministic transformation function the alphanumeric input to the alphanumeric output corresponding to the key cutting code. The key manufacturing apparatus manufactures a key corresponding to the key cutting code.

### BRIEF DESCRIPTION OF THE DRAWINGS

Preferred embodiments of the present invention will now be described, by way of example only, with reference to the following drawings in which:

FIG. 1 illustrates a method according to the prior art for reproducing a key using a key cutting code;

FIG. 2 is a flowchart illustrating methods for producing a lock and key, and for reproducing a key, according to embodiments of the present invention;

FIG. 3 illustrates a system for producing a lock and key according to embodiments of the present invention;

FIG. 4 illustrates a system for reproducing a key according to embodiments of the present invention; and

FIG. 5 illustrates a system for implementing aspects of the present invention.

### DETAILED DESCRIPTION

It would be desirable to provide an improved method for reproduction of a user's key which does not require the user to provide to a key cutting facility either a master key or a key cutting code for key reproduction.

An embodiment of the present disclosure provides a method for producing a lock and matching key including the following operations (not necessarily in the following order): receiving from a user an alphanumeric input which includes personally selected alphanumeric input; converting by a deterministic transformation function the alphanumeric input to an alphanumeric output corresponding to a key cutting code; and manufacturing a lock and matching key corresponding to the key cutting code.

Some embodiments of the present disclosure may include one, or more, of the following characteristics, features and/or advantages: (i) uses a deterministic transformation function including a one-way function; (ii) uses a deterministic transformation function including a hashing function; (iii) uses a personally selected alphanumeric input comprising a password or passphrase; (iv) uses a personally selected alphanumeric input including an answer to a challenge question; (v) uses an alphanumeric input including the personally selected alphanumeric input combined by the user with a cryptographic salt; and/or (vi) provides for the cryptographic salt being obtained from a visible indicia associated with the lock.

An embodiment of the present disclosure is directed to a method for producing a key, the method including the following operations (not necessarily in the following order): identifying a deterministic transformation function previously used to convert a received alphanumeric input, which included a personally selected alphanumeric input, to an alphanumeric output corresponding to a key cutting code; receiving the same alphanumeric input from a user; converting by the deterministic transformation function the alphanumeric input to the alphanumeric output corresponding to the key cutting code; and manufacturing a key corresponding to the key cutting code.

Some embodiments of the present disclosure may include one, or more, of the following characteristics, features and/or advantages: (i) cutting a key from a key blank in a key cutting apparatus responsive to a provided key cutting code; (ii) using a 3D printer to produce a key; and/or (iv) using a deterministic transformation function by a service provided by a network connected processor.

According an embodiment of the present disclosure, a system for producing a lock and matching key includes: a user input processor for receiving from a user an alphanumeric input which includes personally selected alphanumeric input; an input information transformation processor for converting by a deterministic transformation function the alphanumeric input to an alphanumeric output corresponding to a key cutting code; and a lock and key manufacturing apparatus for manufacturing a lock and matching key corresponding to the key cutting code.

Some embodiments of the present disclosure may include one, or more, of the following characteristics, features and/or advantages: (i) using a deterministic transformation function including a one-way function; (ii) using a deterministic transformation function including a hashing function; (iii) using a personally selected alphanumeric input including a password or passphrase; (iv) using a personally selected alphanumeric input that includes the answer to a challenge question; (v) using personally selected alphanumeric input combined by the user with a cryptographic salt; and/or (vi) use of a cryptographic salt obtained from a visible indicia associated with the lock.

According to an embodiment of the present disclosure, a system for producing a key includes: an identifying component for identifying a deterministic transformation function previously used to convert a received alphanumeric input, which included personally selected alphanumeric input, to an alphanumeric output corresponding to a key cutting code; a user input processor for receiving the same alphanumeric input from a user; an input information transformation processor for converting by the deterministic transformation function the alphanumeric input to the alphanumeric output corresponding to the key cutting code; and a key manufacturing apparatus for manufacturing a key corresponding to the key cutting code.

Some embodiments of the present disclosure may include one, or more, of the following characteristics, features and/or advantages: (i) the manufacturing apparatus includes a key cutting apparatus for cutting a key from a key blank responsive to a provided key cutting code; (ii) a manufacturing apparatus including a 3D (three dimensional) printer to produce a key; and/or (iii) use of a deterministic transformation function of the input information transformation processor by a service provided by a network connected processor.

According to an embodiment of the present disclosure, a computer program includes computer program code stored on a computer readable medium to, when loaded into a computer system and executed thereon, cause the computer system to perform all the steps of the method embodiments set forth above.

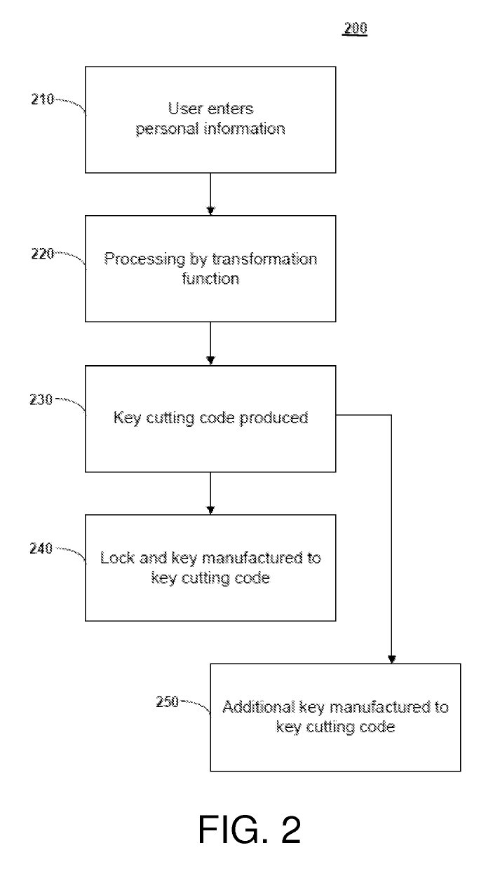

FIG. 2 illustrates a flowchart showing a method 200 for producing a lock and a corresponding key according to a preferred embodiment of the present invention. According to this embodiment, a user provides some personally selected user information which may be used to produce a lock and key corresponding to the provided user information. Subsequently, the same user information may be used to produce a duplicate key.

At step 210 a user provides information, for example in answer to a question or questions, a personally selected password or passphrase or some other memorable and secret information. The input information is transferred to an input information transformation processor at step 220. The input information transformation processor comprises a deterministic transformation function, that is a transformation function comprising a transformation algorithm producing an identical output given identical input, which processes the user input information to produce a key cutting code at step 230. This key cutting code is then used at step 240 to produce a lock and matching key corresponding to this key cutting code. Subsequently, a copy of the key may be produced by providing the same user information at step 210, the transformation function processing it at step 220 to produce an identical resulting key cutting code at step 230, and an additional key identical to the original being produced at step 250.

In method 200, the deterministic transformation function used at step 220 includes a one-way function. A one-way function is a mathematical function which is straightforward to compute in one direction but very difficult to reverse, so that in practice it is only computable in one direction. Therefore, given a function f, it is easy to compute f(x)=y given input x, but very difficult to find x given y. User input is therefore protected from discovery should the output be obtained.

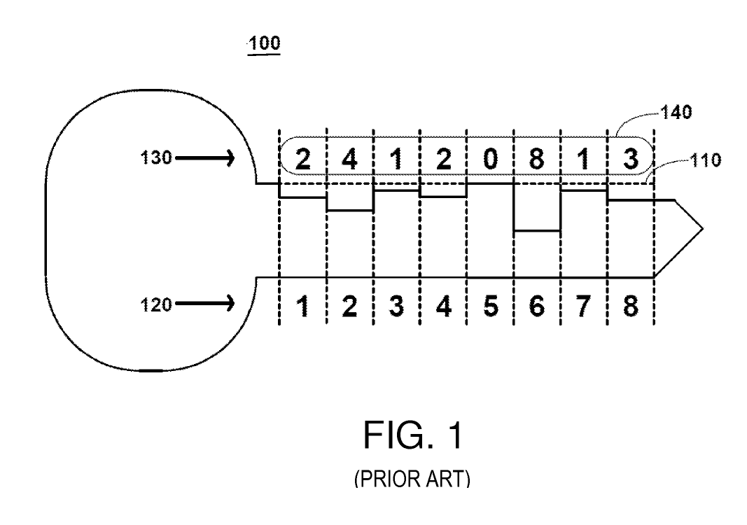

In method 200, the deterministic transformation function includes a hashing function wherein the product of the input and the hashing function is a hash value which, as a whole or a particular defined part of the hash value (for example the first eight digits), may be used as a key cutting code which represents the key profile as described, for example, in the prior art method as described with reference to FIG. 1, as described, above, in the Background section. The hash function will typically also be a one-way function. In method 200, the hash function is chosen so that, when the user input is processed using it, a hash value having the correct number of digits is produced to provide a key cutting code for the required lock and key.

In some embodiments, a random unique “salt” is combined with the user-provided input, for example the user-provided password, passphrase or answer to question or questions posed, before processing by the transformation function. The salt comprises, for example, an extra number which is unique to the lock and which may be printed on the face of the lock. The use of user input that includes such “cryptographic salt” as input to the deterministic transformation function renders dictionary-like attacks to obtain the user input much more difficult. The use of a salt to protect against dictionary-like attacks to obtain user input is a known technique in other areas of cryptography.

In some embodiments, the deterministic transformation function includes the use of an application program which is operable for receiving the answer or answers to a question or series of questions posed, the answer or answers providing the input for the transformation function.

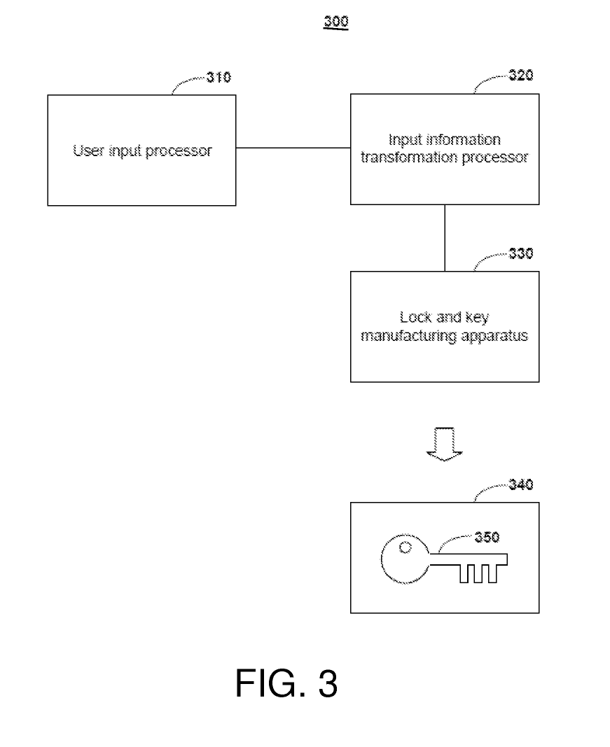

FIG. 3 illustrates a lock and key manufacturing system 300 according to an embodiment of the present disclosure. User input processor 310 comprises the system interface to the user. This may include a terminal combining, for example, a display or other output means with user input means, for example a keyboard. In system 300, user input processor 310 includes a personal computer or other device which may be connected to a telecommunications network such as the internet. In system 300, user input processor 310 includes application software operable for presenting an interrogation interface to the user and for storing and/or transmitting via a network connection user responses. In system 300, user input processor 310 includes an internet interface such as a web browser interface. User input processor 310 may include locally and/or remotely located software and/or hardware components. In system 300, user input processor 310 includes a software service, such as a web service, provided by an online provider.

In system 300, to initiate the process of manufacture of a lock and matching key, the user provides some personally selected information. In system 300, user input processor 310 presents to the user a question or set of questions for which the answer or answers may be memorable to the user but not obvious to third parties (for example, name of first school, name of first pet, favorite place) and prompts the user to input the answer or answers. In some embodiments, the user may be asked to provide other personally selected information such as a user password or passphrase. In some embodiments, and in addition to providing this input information, the user may be asked to compose in a setup operation a question or set of questions for which an answer or answers will be requested. In each case, the user provided input which results comprises the basis for the next element of the system, input information transformation processor 320.

Input information transformation processor 320 includes computational logic including a deterministic transformation function, that is, a transformation function comprising a transformation algorithm which produces the same output when presented with a given input, for converting the user provided input into a key cutting code. In system 300, information transformation processor 320 includes a one way function as described above. In system 300, the one-way function is a hash function whose output may be used to provide a key cutting code as described above. In system 300, input information transformation processor 320 includes a computing apparatus which is situated adjacent to user input processor 310. In some embodiments, an input information transformation processor is situated locally or remotely and connected to a telecommunications network such as the internet and may be accessed thereby. In system 300, input information transformation processor 320 includes application software comprising a deterministic transformation function operable for computing a key cutting code from input provided by user input processor 310. Input information transformation processor 320 includes locally and/or remotely located software and/or hardware components. In system 300, input information transformation processor 320 includes a software service, such as a web service, provided by an online provider.

In system 300, user input processor 310 and input information transformation processor 320 together comprise a single entity, which single entity may comprise a completely software embodiment or a completely hardware embodiment or any combination of software and hardware elements. In each case elements of the embodiments may be distributed locally to and/or remotely from the user.

Output from information transformation processor 320 is presented as a key cutting code to lock and key manufacturing apparatus 330. Lock and key manufacturing apparatus 330 may include any conventional apparatus as known in the art, or to be developed in the future. In system 300, a user may request a lock and key having gone through the process of setting up and entering user information as described above. In system 300, the request is made as part of a service offered by a lock supplier. The lock supplier may produce a complete lock 340 and key 350, or in some cases merely the replaceable part of a lock mechanism and a matching key. For example, in lock designs comprising a common generic lock structure and a replaceable barrel mechanism, a barrel mechanism and matching key may be supplied.

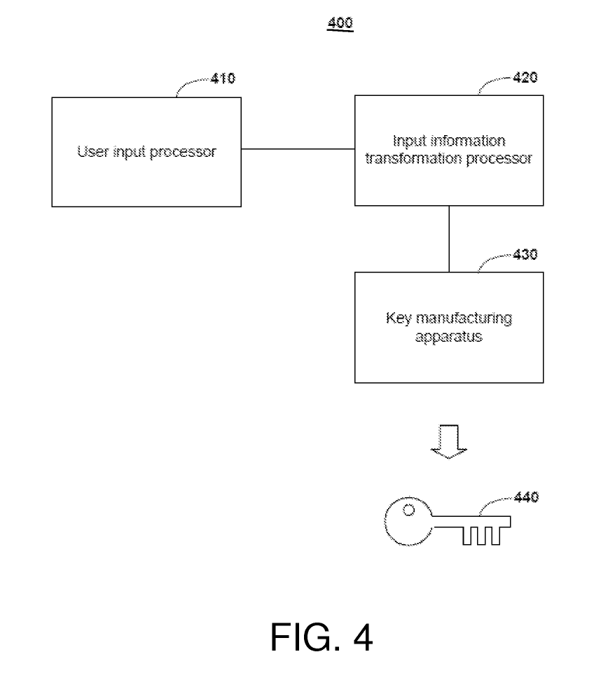

FIG. 4 illustrates a replacement key manufacturing system 400 according to an embodiment of the present invention. The key manufacturing system is for use by a user who has already obtained a lock and key manufactured by a system substantially as described above with reference to FIG. 3. An advantage of the system is that it is possible to design a scheme of operation which minimizes the exposure of a key cutting code.

In system 400, the system is part of a service offered by a lock and key manufacturer. The lock and key manufacturer has provided a lock and key as described with reference to FIG. 3, above. When a user requires a new key for the lock previously provided, the user initiates user input processor 410 which is functionally similar to user input processor 310 described with reference to FIG. 3, and may be embodied, for example, as any of the alternative arrangements described with reference to FIG. 3. In this case, the user may indicate, typically by answer to a question posed by a user interface to user input processor 410, that a key only is required rather than a lock and key.

The user prompts which are provided by user input processor 410 are functionally identical to those provided by user input processor 310 of the system for manufacture of lock and key described with reference to FIG. 3. The user will be presented with the same question or questions, or as the case may be the same request for a password or passphrase. The answer or answers should be the same as previously, and so the same information will be passed to input information transformation processor 420. Input information transformation processor 420 comprises the same transformation function as input information transformation processor 320 and therefore the output will also be the same.

The output in the form of a key cutting code, which will be the same as that produced in the original process of manufacture of lock and key as described above, is passed to key manufacturing process 430. A functionally identical key which will operate the original lock will therefore be produced from the identical key cutting code. It will be apparent to the skilled person that many arrangements of the key manufacturing system described with reference to FIG. 4 may be envisaged without departing from the scope of the invention.

In one embodiment, the manufacturer of the original lock and key provides a key replacement service in like manner to that described above for providing a lock and key with reference to FIG. 3. In this embodiment, a user will initiate the service in a manner analogous to that used to produce the original lock and key. In one embodiment, the key cutting code produced is used by the manufacturer to cut a key which is delivered to the user. In one embodiment, the user accesses the service at their local computer and instructs a remote key manufacturing service, such as a key cutting service, to produce the key which may then be delivered to or collected by the user.

In another embodiment, the user accesses the service at a key cutting station which embodies the elements of the invention, for example in a key cutting shop or at a key cutting kiosk. In an embodiment, a key cutting kiosk provides a self-contained key cutting station. The kiosk may comprise a display screen on which user input processor 410 presents a user input interface. The user is presented with challenge questions as previously described. The user enters the same information as previously provided to produce the lock and key as described above with reference to FIG. 3. Entry of this information may be by any suitable data entry means, for example a keyboard, or a touch screen.

Input information transformation processor 420 includes software implementing the transformation algorithm as previously described, and executing on processing hardware within the kiosk. Alternatively, an input information transformation processor may include an exclusively hardware embodiment in a dedicated computing processor within the kiosk, or a combination of hardware and software elements. Alternatively, some or all of the processing may be accomplished at a remote location communicating with the kiosk via a communication network such as the internet. As described previously, an input information transformation processor include an internet service, such as a web service, provided by a manufacturer or other provider.

Operation of the transformation algorithm produces a key cutting code as described previously, which, providing that the user input is the same, is the same as that produced to make the original lock and key. The key cutting code is passed to key manufacturing apparatus 430 which may be embodied as part of the kiosk apparatus. In this embodiment, key manufacturing apparatus 430 is a conventional key cutting machine to which is presented an appropriate key blank, either by the user or automatically from a magazine or similar store of blanks. On presentation of the blank and cutting by the machine, a key 440 corresponding to the correct key cutting code is presented to the user.

In another embodiment, the key manufacturing apparatus includes a 3D printing apparatus. 3D printing is the term used for a process of making a three-dimensional solid object by the laying down of successive layers of an extrudable and settable material from a moving dispenser. The apparatus may include the printer itself and associated control mechanism, typically a computer processing apparatus. The material used in 3D printers typically includes one or more plastics materials, for example acrylonitrile butadiene styrene (ABS), although in some 3D printing apparatus a molten metal may be used to produce a metal object.

In system 400, the 3D printer in key manufacturing apparatus 430 is instructed by input information transformation processor 420 to print a key corresponding to the output key cutting code. In one embodiment, the 3D printer is part of the kiosk apparatus as described above. In system 400, no supply of key blanks is required. An advantage of this is that it provides more flexibility in the types of key which may be produced by the kiosk. If the key 440 is printed from a plastics material such as ABS, it is likely to have limited durability. It may function as a key for use once only, or for use a limited number of times. Alternatively, the plastic key may be presented to a locksmith or similar provider of key cutting services so that it may be duplicated from a metal key blank on a conventional key cutting machine to form a duplicate metal key as in any conventional method or method to be developed in the future.

In a further embodiment, the 3D printer may be in a user location, for example at home. All the elements of the key duplicating system may thus be accessible to the user in her own home, using her own computing and 3D printing apparatus. User input processor 410 and input information transformation processor 420 may be provided in a user's computer processing equipment, embodied in any mixture of software and hardware elements. Alternatively, and as described previously, the user input processor and input information transformation processor may be provided, for example by a service provider, partly or wholly via a network communication, for example as a web service, and therefore accessible to the user as required. It will be apparent to a person skilled in the art that many other arrangements are possible. For example, provision of the processing aspects of the invention as described as a web service would potentially allow a user to access the service at any location at which is provided suitable computing and 3D printing capability allowing great flexibility in operation.

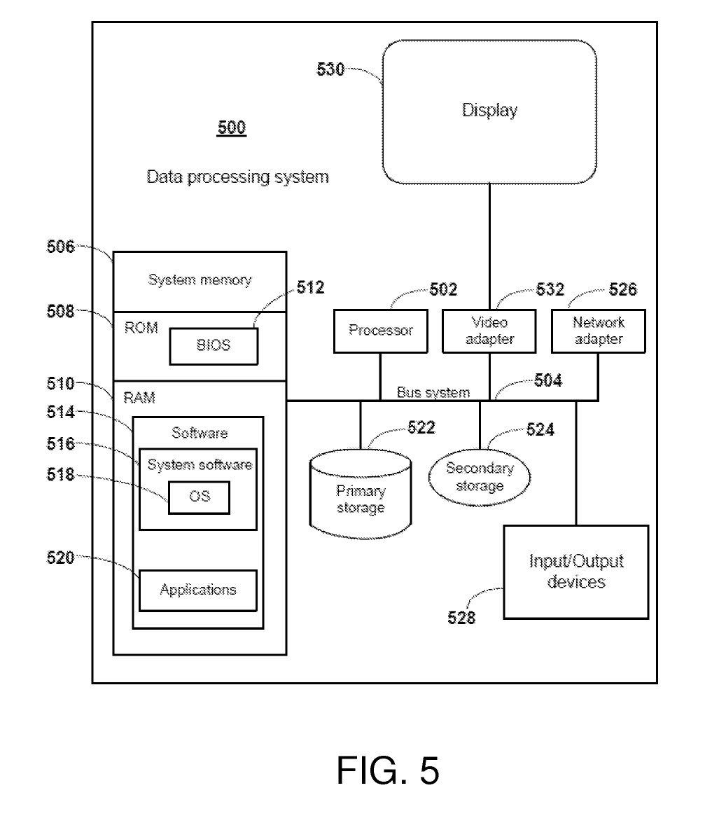

FIG. 5 illustrates data processing system 500 for implementing aspects of the present invention. Data processing system 500 is operable for storing and/or executing program code and includes at least one processor 502 coupled directly or indirectly to memory elements through a system bus 504. The memory elements may comprise local memory employed during actual execution of the program code, bulk storage memory, and cache memory for providing temporary storage of at least some program code in order to reduce the number of times program code must be retrieved from bulk storage during program execution.

In system 500, memory elements include system memory 506 in the form of non-volatile read only memory (ROM) 508 and volatile random access memory (RAM) 510. A basic input/output system (BIOS) 512 may be stored in ROM 508. Software 514 is stored in RAM 510. Software 514 includes system software 516, which includes operating system software 518, and software applications 520.

In system 500, the memory elements further include primary storage means 522 which may comprise a magnetic hard disc drive, and secondary storage means 524 which may comprise an optical disc drive or a magnetic disc drive. The primary and secondary storage means and their associated computer-readable storage media provide non-volatile storage of computer-executable instructions, data structures, program modules and other data for data processing system 500. Software applications may be stored on the primary and secondary storage means 522, 524 as well as in system memory 506.

Data processing system 500 operates in a networked environment using logical connections to one or more remote data processing systems via network adapter 526.

Input/output (I/O) devices 528 is coupled to the system either directly or through intervening I/O controllers. A user may enter commands and information into system 500 through input devices such as a keyboard, pointing device such as a mouse, or other input devices such as microphone, joystick, trackball, touchpad, game controller, satellite dish, scanner etc. Output devices may comprise printers, speakers etc. Display device 530 is connected to system bus 504 via an interface including video adapter 532.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following paragraphs set forth some definitions to be used in understanding this document.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for producing a lock and matching key, the method comprising:
receiving an alphanumeric input from a user, the alphanumeric input includes a personally selected alphanumeric input;
converting by a deterministic transformation function the alphanumeric input to an alphanumeric output corresponding to a key cutting code; and
manufacturing a lock and matching key corresponding to the key cutting code.

2. The method according to claim 1 wherein the deterministic transformation function comprises a one-way function.

3. The method according to claim 2 wherein the deterministic transformation function includes a hashing function.

4. The method according to claim 1 wherein the deterministic transformation function includes a hashing function.

5. The method according to claim 1 wherein the personally selected alphanumeric input includes a password or passphrase.

6. The method according to claim 1 wherein the personally selected alphanumeric input includes the answer to a challenge question.

7. The method according to claim 1 wherein the alphanumeric input further includes a cryptographic salt, with the personally selected alphanumeric input being combinable by the user with the cryptographic salt.

8. The method according to claim 7 wherein the cryptographic salt is obtained from a visible indicia associated with the lock.

9. A method for producing a key, the method comprising:
identifying a deterministic transformation function previously used to convert a received alphanumeric input including a personally selected alphanumeric input to an alphanumeric output corresponding to a key cutting code;
receiving the same alphanumeric input from a user;
converting by the deterministic transformation function the alphanumeric input to the alphanumeric output corresponding to the key cutting code; and
manufacturing a key corresponding to the key cutting code.

10. The method according to claim 9 wherein the manufacturing includes cutting a key from a key blank in a key cutting apparatus responsive to a provided key cutting code.

11. The method according to claim 9 wherein the manufacturing includes using a 3D (three dimensional) printer to produce the key.

12. The method according to claim 9 wherein the conversion of the deterministic transformation function is performed by a service provided by a network connected processor.

13. A system for producing a key, the system comprising:
an identifying component for identifying a deterministic transformation function previously used to convert a received alphanumeric input comprising a personally selected alphanumeric input to an alphanumeric output corresponding to a key cutting code;
a user input processor for receiving the same alphanumeric input from a user;
an input information transformation processor for converting by the deterministic transformation function the alphanumeric input to the alphanumeric output corresponding to the key cutting code; and
a key manufacturing apparatus for manufacturing a key corresponding to the key cutting code.

14. The system according to claim 13 wherein the manufacturing apparatus includes a key cutting apparatus for cutting a key from a key blank responsive to a provided key cutting code.

15. The system according to claim 14 wherein the deterministic transformation function of the input information transformation processor includes access of a service provided by a network connected processor.

16. The system according to claim 13 wherein the manufacturing apparatus comprises a 3D (three dimensional) printer to produce the key.

17. The system according to claim 16 wherein the deterministic transformation function of the input information transformation processor includes access of a service provided by a network connected processor.

18. The system according to claim 13 wherein the deterministic transformation function of the input information transformation processor includes access of a service provided by a network connected processor.
